(19) United States
(12) Patent Application Publication
(10) Pub. No.: US 2015/0059620 A1
(43) Pub. Date: Mar. 5, 2015

(54) HORIZONTAL MIXER FOR BITUMINOUS MIXTURES

(71) Applicant: D&H Equipment, LTD, Blanco, TX (US)

(72) Inventors: Andrew Tilman Cox, Blanco, TX (US); Jason Cox, Blanco, TX (US)

(73) Assignee: D&H Equipment, LTD, Blanco, TX (US)

(21) Appl. No.: 14/018,838

(22) Filed: Sep. 5, 2013

(51) Int. Cl. B01F 3/12; C08L 95/00

(52) U.S. Cl. CPC B01F 3/1214; C08L 95/00
USPC 106/273.1

(57) ABSTRACT

A mixer for combining solid material such as asphalt shingles and/or recycled asphalt with asphalt binder. A method of using the mixer includes inputting large chunks of solid material to a first inlet of the mixer, inputting liquid asphalt binder to a second inlet of the mixer, passing the large chunks of solid material and the asphalt binder through a mixer chamber having a first stage and a second stage, the first stage comprising a helical screw and the second stage comprising a plurality of paddles, and obtaining a uniform mixture comprising small chunks of solid material and asphalt binder from the mixer.

### CROSS-REFERENCE TO RELATED APPLICATION

This application claims the benefit of U.S. Provisional Application No. 61/975,575 filed Sep. 6, 2012, the entire contents of which are incorporated herein by reference for all purposes.

### BACKGROUND

The present disclosure is directed to a mixer for bituminous material. The mixer is particularly suited for combining large chunks of solid material with liquid bitumen to provide a uniformly mixed bituminous mixture.

Mixtures of bitumen and aggregate, commonly known as asphalt, are used in a wide variety of applications, particularly in the construction and maintenance of roads. The bitumen acts as a binder, coating individual aggregate particles and binding them together in the final composition. Other asphalt binders are used without aggregate to seal or coat surfaces.

Asphalt binders generally comprise residue from petroleum refining processes. In addition to the aggregate, many times property-enhancing additives are added to the residue in order to alter the properties of the asphalt binder.

### SUMMARY

The present disclosure describes a mixer suitable for providing a bituminous mixture, the mixture being a combination of asphalt binder, any aggregate, and any additives. This disclosure describes the use of a continuous mixer configured to provide a uniform mixture from large chucks of solid material, asphalt binder and any additives, and any aggregate. The mixer is configured to uniformly disperse aggregate, asphalt binder and additives among the solid material. The mixer is configured to mix, combine, heat, melt, and/or reduce in size the ingredients to produce a uniformly mixed bituminous or asphalt mixture.

One particular embodiment of this disclosure is a method of forming a bituminous mixture. The method comprises inputting asphalt shingles to a first inlet of a mixer, inputting liquid asphalt binder to a second inlet of the mixer, passing the asphalt shingles and the asphalt binder through a mixing chamber having a first stage and a second stage, the first stage comprising a helical screw and the second stage comprising a plurality of paddles, and obtaining a uniform mixture comprising asphalt shingle chunks and asphalt binder from the mixer. The second inlet may be the same or different than the first inlet; if different, the second inlet can be downstream of the first inlet.

Another particular embodiment of this disclosure is a method of forming a bituminous mixture by inputting large chunks of solid material to a first inlet of a mixer, inputting liquid asphalt binder to a second inlet of the mixer, passing the large chunks of solid material and the asphalt binder through an inclined mixer chamber having a first stage and a second stage, the first stage comprising a helical screw and the second stage comprising a plurality of paddles, and obtaining a uniform mixture comprising small chunks of solid material and asphalt binder from the mixer. The solid material may include asphalt shingles and/or recycled asphalt. The paddles reduce the large chunks of solid material to small chunks of solid material.

These and various other features and advantages will be apparent from a reading of the following detailed description.

### BRIEF DESCRIPTION OF THE DRAWING

The invention may be more completely understood in consideration of the following detailed description of various embodiments of the invention in connection with the accompanying drawing, in which:

FIG. 1 is a cross-sectional view of a mixer according to the present disclosure.

FIG. 2 is a front view of the output end of the mixer of FIG. 1.

### DETAILED DESCRIPTION OF THE INVENTION

The present disclosure is directed to a continuous mixer and methods of using that mixer to produce a bituminous or asphalt mixture.

In the following description, reference is made to the accompanying drawing that forms a part hereof and in which are shown by way of illustration at least one specific embodiment. The following description provides additional specific embodiments. It is to be understood that other embodiments are contemplated and may be made without departing from the scope or spirit of the present invention. The following detailed description, therefore, is not to be taken in a limiting sense. While the present invention is not so limited, an appreciation of various aspects of the invention will be gained through a discussion of the example provided below.

Unless otherwise indicated, all numbers expressing feature sizes, amounts, and physical properties are to be understood as being modified by the term “about.” Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

As used herein below, “RAZ” means recycled asphalt shingles. These shingles may be completely new (i.e., uninstalled) shingles, shingles rejected from the factory, by a supplier or a consumer for one reason or another (e.g., wrong size, wrong color, bent, broken, etc.), or may be previously installed shingles.

As used herein below, “RAP” means recycled asphalt. The asphalt is composed of asphalt binder and aggregate. Typically, the material is solid rather than liquid or semi-liquid. The asphalt may be reclaimed, for example from a roadbed or other application, or may be waste material that for one reason or another was not installed.

The mixer of this disclosure is designed to mix liquid asphalt with any other ingredient that needs to be mixed, heated, melted, reduced in size, or any combination of the above. The mixer is a continuous-type mixer, having a separate inlet and outlet. The interior chamber of the mixer includes a helical screw and paddles and/or breaker bars. The screw pushes material through the interior chamber, much like a pump. The paddles mix the materials together and the breaker bars can reduce the physical size of the material.

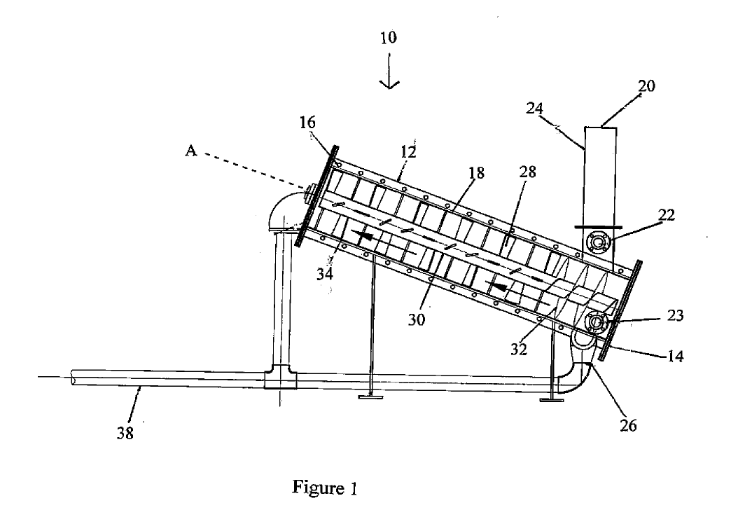

Referring to FIG. 1, a mixer 10 is illustrated. Mixer 10 has an elongate, cylindrical body 12 extending from a first end 14 to a second opposite end 16 along axis line A. Present within body 12 is an elongate, cylindrical interior chamber 18 through which material being processed passes. First end 14 can be referred to as the inlet end, end 14 having at least one inlet into interior chamber 18 proximate thereto. In the illustrated embodiment, mixer 10 has a first inlet 20, a second inlet 22 and a third inlet 23, each in fluid communication with and operably connected to interior chamber 18. First inlet 20 is configured as a solids inlet 20, second inlet 22 is configured as a liquid inlet 22, and third inlet 23 is also configured as a liquid inlet 23. Solids inlet 20 and liquid inlet 22 are located on an inlet stack 24, positioned above body 12. A high level safety switch may be present on stack 24. First end 14 also includes a drain 26 operably connected to interior chamber 18. Any materials exiting via drain 26 passes to a pump or drum mixer (not shown) via piping 38.

In some embodiments, mixer 10 may be referred to as a horizontal mixer, with interior chamber 18 configured to move material present therein in a generally longitudinal direction, one having a horizontal component. Although referred to as a “horizontal” mixer, mixer 10 is angled, sloped or inclined, with the output end, second end 16, positioned higher than the input end, first end 14. In some embodiments, second end 16 is vertically adjustable, to modify the incline of mixer 10. The desired incline is dependent on the input material and the desired output material.

Present within interior chamber 18 is a mixing element 28 having a first stage and a second stage, the first stage being closer to the input end, first end 14, than the second stage. In other words, the second stage is downstream of the first stage. In the illustrated embodiment, the first stage occupies approximately the upstream-most 20-30% of the length of interior chamber 18, and the second stage occupies approximately the downstream-most 70-80% of the length of chamber 18. It is understood that the relativity of the first stage and the second stage can be modified, depending on the specific mixing element 28 and materials to be processed.

The first stage of mixing element 28 includes a helical screw 32 extending around and out from a central shaft 30. Helical screw 32 may be one continuous flight or may be formed by a plurality of smaller flights. Screw 32 may be a single helix or a double helix. The second stage of mixing element 28 includes a plurality of paddles or bars 34 extending around and out from central shaft 30. Paddles/bars 34 are downstream from helical screw 32. Screw 32 pushes material from inlet end 14 through interior chamber 18 to paddles/bars 34, which mix the materials together and optionally reduce the size of the solid material. Mixing element 28 can be powered by a gearbox and electric motor (not shown). Mixing element 28 may have a single set speed (e.g., 200 rpm), multiple set speeds (e.g., 100 rpm, 200 rpm and 300 rpm), or may have variable speeds.

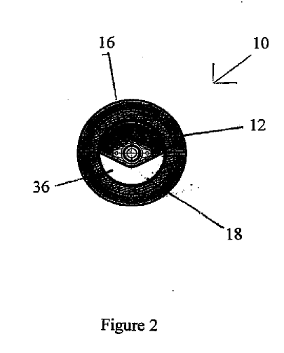

As illustrated in FIG. 2, at second end 16, body 12 includes an outlet 36 in fluid communication with and operably connected to interior chamber 18. From outlet 36, material from interior chamber 18 passes to a pump or drum mixer (not shown) via piping 38. In some embodiments, a pump may be present at outlet 36 or in piping (not shown) to assist in pushing material exiting outlet 36 to the drum mixer.

Referring back to FIG. 1, mixer 10 is preferably insulated and optionally heated to maintain a low viscosity of the material within interior chamber 18. For example, body 12 may be insulated with a 1 inch R rated insulation. Chamber 18 may be heated via hot oil external to body 12, via electric heating elements within body 12, or via plug heaters or the like extending into chamber 18. Body 12 may be jacketed with a metal jacket over the insulation and/or over any heating mechanism. Various temperature probes and high temperature alarms may be present.

Mixer 10 is particularly useful for mixing together bituminous materials, including bitumen (asphalt binder), any binder additives such as surfactants, emulsifiers, etc., and aggregate. Because of the particular configuration of mixing element 28, mixer 10 is particularly suited for receiving physically large materials and reducing the material down to a suitable size. Recycled asphalt shingles (RAZ) are one example of a solid material that can be provided to mixer 10 to be combined with bitumen (asphalt binder) to provide a useable bituminous material. Recycled asphalt (RAP) is another example of a material that can be provided to mixer 10, either as a solid, semi-solid or a liquid, to be combined with bitumen (asphalt binder) to provide a useable bituminous material. Other materials, such as binder additives, aggregate, polymer, warm mix additive, and crumb rubber, could also be added.

Sizes for body 12 of mixer may be as small as 20 inch diameter up to about 26 inches diameter, and as short as 78 inches and as long as 14 feet. Typically, the diameter of body 12 does not increase proportionately with the length of body 12. Of course, larger and smaller mixers (in either or both length and diameter) may be useful for certain applications. Inlets 20, 22, 23, particularly solids inlet 20 and any other inlet through which solid material (e.g., RAZ, RAP, aggregate, etc.), are sized and shaped to allow large chunks of material to be fed to interior chamber 18. Typical mixing rates for mixer 10 are from 7.5 tons/hour of material up to 35 tons/hour at about 70% by weight of solids (depending on density). Of course, lower levels of solids, such as 50%, 55%, 60%, 65%, and everything therebetween could be run through mixer 10. Depending on the input material (particularly, the size, composition, etc. of the RAZ and/or RAP) the amount of solids could be as high as 75% by weight.

The RAZ material is provided to mixer 10 via solids inlet 20. Because of the configuration of mixing element 28, the inputted RAZ material may be any size, as long as it fits in inlet 20. Additionally or alternately, solid RAP material is provided to mixer 10 via solids inlet 20. Because of the configuration of mixing element 28, the inputted RAP material may be any size, as long as it fits in inlet 20. Asphalt binder is added via either or both liquid inlet 22 and inlet 23. In some embodiments, the binder may be added through inlet 23 and additives such as surfactant, emulsifier, polymer, etc. are added through inlet 22. Other solids, such as aggregate and crumb rubber may also be added via solids inlet 20.

From the various inlets 20, 22, 23, the material is carried by helical screw 32 up through interior chamber 18. Typically helical screw 32 merely lifts or pushes the material, although some larger pieces or chunks of solid material (e.g., RAZ) may be reduced in size. From helical screw 32, the material progresses to paddles/bars 34, which beat the material and breaks the solid material into suitable size. It is mixing element 28, having both helical screw 32 and paddles/bars 34, which provides for large chunks of RAZ to be processed and mixed into bituminous material.

After passing through interior chamber 18, the mixed material now comprises small chunks or pieces of RAZ and/or RAP homogeneously mixed with the asphalt binder and other ingredients. The incline of body 12 may be increased or decreased as needed, to adjust the residence time of the material within interior chamber 18. The percentage of solid materials (i.e., RAZ, RAP, etc.) will affect the desired incline of body 12.

The previous described embodiments of the horizontal mixer are not limiting, and variations on the mixer are within the scope of this disclosure. For example, in some embodiments, inlet stack 24 may be longer or shorter; depending on the volume of material (e.g., solid material) desired to be retained. As another variant example, more or less inlets may be present in inlet stack 24; in some embodiments, only a solids inlet such as first inlet 20 is located on stack 24, whereas in other embodiments, three or more inlets may be located on stack 24. As a further variant example, inlet stack 24 may be longitudinally removed from first end 14 a predetermined distance towards second end 16, so that material from inlet stack 24 is delivered not at an end of helical screw 32.

Thus, embodiments of the HORIZONTAL MIXER FOR BITUMINOUS MIXTURES are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A method of forming a bituminous mixture, the method comprising:
inputting asphalt shingles to a first inlet of a mixer;
inputting liquid asphalt binder to a second inlet of the mixer;
passing the asphalt shingles and the asphalt binder through a mixing chamber having a first stage and a second stage, the first stage comprising a helical screw and the second stage comprising a plurality of paddles; and
obtaining a uniform mixture comprising asphalt shingle chunks and asphalt binder from the mixer.

2. The method of claim 1 wherein the second inlet is different than the first inlet.

3. The method of claim 2 wherein the second inlet is downstream of the first inlet.

4. The method of claim 1 wherein the second stage is downstream of the first stage.

5. The method of claim 4 wherein the first stage occupies about 20-30% of the length of the mixing chamber.

6. The method of claim 1 wherein the paddles reduce the asphalt shingles to asphalt shingle chunks.

7. The method of any of claim 1 wherein the mixer is an inclined horizontal mixer.

8. A method of forming a bituminous mixture, the method comprising:
inputting large chunks of solid material to a first inlet of a mixer;
inputting liquid asphalt binder to a second inlet of the mixer;
passing the large chunks of solid material and the asphalt binder through an inclined mixing chamber having a first stage and a second stage, the first stage comprising a helical screw and the second stage comprising a plurality of paddles; and
obtaining a uniform mixture comprising small chunks of solid material and asphalt binder from the mixer.

9. The method of claim 8 wherein the solid material comprises asphalt shingles.

10. The method of claim 8 wherein the solid material comprises recycled asphalt.

11. The method of claim 8 wherein the paddles reduce the large chunks of solid material to small chunks of solid material.

12. The method of claim 8 wherein the uniform mixture comprises about 50-75% solids by weight.

13. The method of claim 12 wherein the uniform mixture comprises about 70% solids by weight.
